(19) United States
(12) Patent Application Publication
(10) Pub. No.: US 2022/0319494 A1
(43) Pub. Date: Oct. 6, 2022

(54) END TO END SPOKEN LANGUAGE UNDERSTANDING MODEL

(71) Applicant: International Business Machines Corporation, Armonk, NY (US)

(72) Inventors: Samuel Thomas, White Plains, NY (US); Hong-Kwang Kuo, Pleasantville, NY (US); George Andrei Saon, Stamford, CT (US); Zoltan Tueske, White Plains, NY (US); Brian E. D. Kingsbury, Cortlandt Manor, NY (US)

(21) Appl. No.: 17/218,618

(22) Filed: Mar. 31, 2021

(51) Int. Cl. G10L 15/06; G06K 9/62; G10L 13/02

(52) U.S. Cl. CPC G10L 15/063; G06K 9/6256; G10L 13/02; G10L 2015/0631

(57) ABSTRACT

An approach to training an end-to-end spoken language understanding model may be provided. A pre-trained general automatic speech recognition model may be adapted to a domain specific spoken language understanding model. The pre-trained general automatic speech recognition model may be a recurrent neural network transducer model. The adaptation may provide transcription data annotated with spoken language understanding labels. Adaptation may include audio data may also be provided for in addition to verbatim transcripts annotated with spoken language understanding labels. The spoken language understanding labels may be entity and/or intent based with values associated with each label.

The following disclosure(s) are submitted under 35 U.S.C. 102(b)(1)(A) as prior disclosures by, or on behalf of, a sole inventor of the present application or a joint inventor of the present application:

1) Submitted Thomas et al., “RNN Transducer Models for Spoken Language Understanding” for consideration to the IEEE International Conference on Acoustics, Speech, and Signal Processing (ICASSP 2021) on Oct. 21, 2020.

### BACKGROUND OF THE INVENTION

The present invention relates generally to the field of spoken language understanding, more specifically, training recurrent neural network transducer models for spoken language understanding.

Spoken language models allow for the conversion of audible utterances into a computer understandable format. Some models involve converting sound waves into phonemes. the phonemes are then converted into text based on predictions of likely phoneme companions and order. The converted text is generally compared to a language model to provide probabilities of word sequences, thus improving the accuracy of speech-to-text outputs. In many cases different models are required for different domains of speech. General purpose and domain based spoken language understanding models require many hours of training, including different dialects, speaking speeds, and volumes.

### SUMMARY

Embodiments of the present disclosure include a computer-implemented method, computer program product, and a system for training an end-to-end spoken language understanding model. Training an end-to-end spoken language understanding model includes initializing a general purpose automatic speech recognition model, wherein the general purpose training data is comprised of a plurality of audio recordings and associated verbatim transcripts and training the general purpose automatic speech recognition model in a specific domain, wherein the training data is the plurality of audio recordings and a plurality of spoken language understanding labels associated with the audio recording. The above summary is not intended to describe each illustrated embodiment of every implementation of the present disclosure.

### BRIEF DESCRIPTION OF THE DRAWINGS

FIG. 1 is a functional block diagram generally depicting an end-to-end spoken language understanding model training environment, in accordance with an embodiment of the present invention.

FIG. 2 is a flowchart depicting a method for training an end-to-end spoken language understanding model, in accordance with an embodiment of the present invention.

FIG. 3 is a functional block diagram of an exemplary end-to-end RNN-T SLU model architecture 300, in accordance with an embodiment of the invention.

FIG. 4 is a functional block diagram of an exemplary computing system within an end-to-end spoken language understanding model training, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted allow for the adaptation of pre-trained automatic speech recognition models to spoken language understanding models. Spoken language understanding (“SLU”) systems typically consist of an automatic speech recognition system (“ASR”) paired with a natural language understanding system. Training these systems in tandem is labor intensive and time consuming. End-to-end SLU systems allow for the conversion of spoken utterances directly into a computer understandable format. End-to-end means there is only one system that inputs spoken utterances and outputs SLU entity or intent labels. Embodiments of the disclosure provide for a single all neural network speech-to-text model with SLU labels attached to the generated text. Conventional ASR systems are typically composed of a separate acoustic model, language model, pronunciation lexicon, and decoder components. A recurrent neural network transducer (“RNN-T”) architecture is an excellent architecture for accomplishing this task and creating models that are more efficient to train and consume fewer computing resources, because the latent space within the RNN-T contains all the information that would be contained within the separate models of a conventional ASR system.

In an embodiment of the invention, a pre-trained ASR model is provided. The pretrained general purpose ASR model is trained with general purpose audio and verbatim transcription data. The general purpose ASR model can be tuned to a domain using audio data containing utterances in the specific domain and verbatim transcriptions for the utterances. Further, the tuned ASR model can be trained in SLU for the domain using the audio data and SLU labels corresponding to important keywords and utterances within the audio data.

In an embodiment of the invention, the pre-trained ASR model is an RNN-T model. The RNN-T consists of a transcription network/acoustic model, a prediction network, and a joint network. The transcription network produces acoustic embeddings. The prediction network generates embeddings for the non-blank symbols produced by the model. The joint network is conditioned to combine the two embeddings of the transcription network/acoustic model and prediction network to produce an output distribution over the output symbols. The symbols are the keywords associated with the domain that contribute to the understanding of the spoken language. It should be noted, the output symbols can also include subword units (e.g., characters) that can flexibly be concatenated to form words.

Embodiments of the current invention have many improvements over current technologies.

A preferred embodiment of the current invention allows for a pre-trained general purpose ASR model using an RNN-T architecture. The RNN-T architecture replaces conventional ASR systems that are comprised of separate acoustic model, language model, pronunciation lexicon and decoder components, by replacing it with an all-neural model. The general purpose ASR model is trained using the domain-specific audio recording data and non-blank SLU labels corresponding to keywords and/or sentence intent in the domain specific audio. Here the joint network has additional output nodes added to it corresponding to the non-blank SLU labels.

In an additional embodiment, domain specific audio data, verbatim transcripts for the audio data, and SLU labels associated with the domain specific audio data may be available for training purposes. The domain specific audio data and verbatim transcripts can be used to tune a general purpose ASR model. The model can be a general speech-to-text model in a neural network architecture (e.g., RNN-T). The model may have two input models, an acoustic model for generating embeddings based on the acoustics or phonemes of the audio recordings and a prediction model for generating embeddings for predicting text based on the audio recordings. The embeddings of the two input models may be fed into an output joint network. The output joint network may have output node corresponding to graphemes, characters, intent labels, etc. The tuned ASR model may be adapted to the domain using audio data and SLU labels corresponding to the audio data. The SLU labels may be annotated to the audio data based on the time at which the corresponding value occurs in the recording. Additionally, adapting the tuned ASR model may include adding additional nodes to the output layer corresponding to the SLU labels in the annotated audio data.

In another embodiment, tuning and/or adapting the general purpose ASR model may include providing the ASR model on a local device (e.g., personal computer, cellular phone, tablet, kiosk, etc. . . . ) and providing a lightweight customizable process to the general purpose ASR model that does not require additional code. Allowing the same training algorithm previously used to train the ASR model but using the domain specific data (i.e. audio data, SLU labels, and/or verbatim transcripts). For example, at a fast food restaurant, a general purpose ASR model may be installed on a kiosk which customers can say their order into. The general ASR model may still be necessary as it recognizes “cheeseburger”, “milkshake”, or “tenders”, however, the fast food restaurant may have irregular names attached to variations of general names. A customer may say “I would like the monster chocoparadise milkshake” or “the petite duck sirloin tenders meal”. In this case, the entity labels for “monster_{B-size.drink}”, “chocoparadise_{B-flavor.drink}” or “petite_{B-size.meal}”, “duck_{B-type.meat}”, “sirloin_{I-type.meat}”. As the restaurant only has a small finite number of flavors, a completely new domain specific ASR model requiring a great deal of resources is not required.

In another embodiment, a general purpose ASR model can be adapted using audio data and SLU labels. The configuration of the adapted SLU model can be saved. These new configurations can include adding additional output nodes to the ASR model and updating parameters within the ASR model to allow for output to the newly added nodes. The resulting changes of this process can be known as adaptation configuration patch (i.e. a delta model). The adaptation configuration patch can be stored in a database, thus saving storage resources, rather than retaining the entire ASR model. For example, the ASR model may be cloud based and require a large amount of storage and memory space to operate. The adaptation configuration patch may be stored in a local device and placed over the general purpose ASR model, allowing for a SLU model to operate by patching the ASR model, rather than storing an entirely different SLU model in the cloud or on a local device.

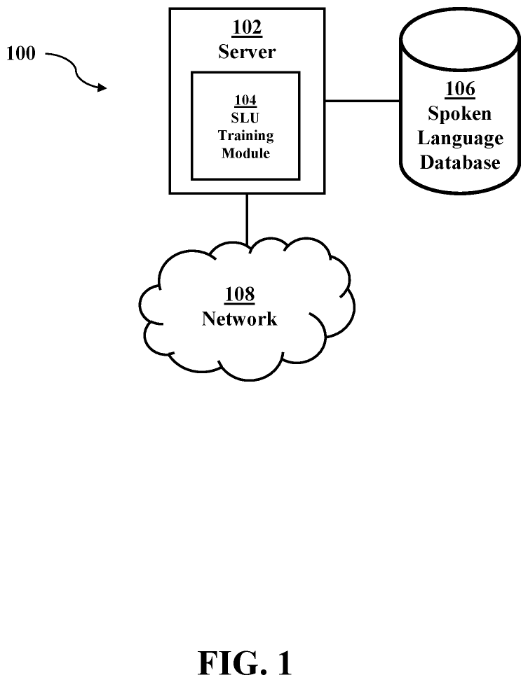

FIG. 1 is a functional block diagram generally depicting an end-to-end spoken language understanding model training environment 100. End-to-end spoken language understanding model training environment 100 comprises SLU training module 104 operational on server 102 and spoken language database 106 stored on server 102, and connected to network 108.

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system. In another embodiment, server 102 can be a laptop computer, a tablet computer, a netbook computer, a personal computer, a desktop computer, or any programmable electronic device capable of communicating with other computing devices within end-to-end spoken language understanding model training environment 100 via network 108.

Network 108 can be a local area network (LAN), a wide area network (WAN) such as the Internet, or a combination of the two, and can include wired, wireless, or fiber optic connections. In general, network 108 can be any combination of connections and protocols that will support communications between servers 102, and external computing devices (not shown).

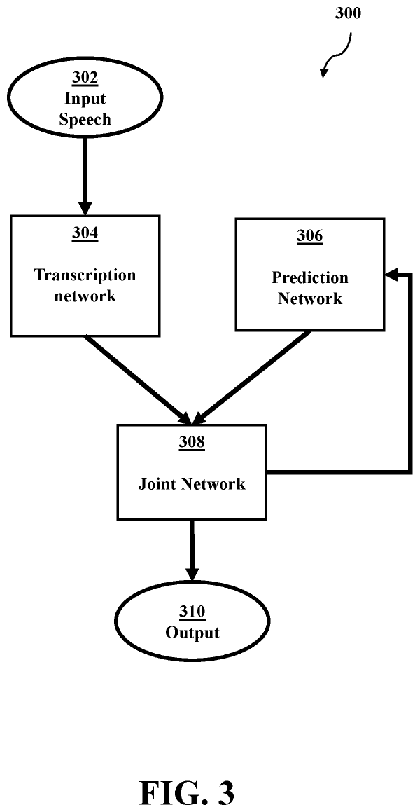

In another embodiment, server 102 represents a computing system utilizing clustered computers and components (e.g., database server computers, application server computers, etc.) that can act as a single pool of seamless resources when accessed within end-to-end spoken language understanding model training environment 100. Server 102 can include internal and external hardware components, as depicted, and described in further detail with respect to FIG. 3. It should be noted, while only Server 102 is shown in FIG. 1, multiple computing devices can be present within end-to-end spoken language understanding model training environment 100. In an example, server 102 can be a part of a cloud server network in which a computing device (not shown) connected to network 108 can access server 102 (e.g., the internet).

Spoken Language Understanding (“SLU”) Training Module 104 is a computer module that can be configured to train an end-to-end spoken language understanding model in a specific domain. In an embodiment, SLU training module 104 can retrieve, initialize, or be provided a general purpose ASR model. For example, a general purpose ASR model can be operational within SLU training module 104. The general purpose ASR model can be an RNN-T with a non-specific transcription network, generalized word prediction network, and an joint network. The transcription network for generating acoustic embeddings and a generalized word prediction network for generating embeddings associated with predicting words or grapheme combinations. The joint network can be a network for receiving the embeddings generated by the transcription and prediction networks to predict grapheme or phonetic tokens.

In an embodiment, the architecture of the general purpose ASR model can be as follows, the transcription network can be a long-short term memory architecture with six bidirectional layers with 640 nodes per layer, per direction. The prediction network can be a single unidirectional long-short term memory architecture with 768 nodes. The output network can project and combine the 1280 dimensional stacked encoder vectors from the final layer of the transcription network and the 768 dimensional embedding down to 256 dimensions. A hyperbolic tangent can be applied to the 256 dimensions and projected to 46 logits, corresponding to 45 characters plus a blank, followed by a softmax layer applied to the 46 logits.

In an embodiment, SLU training module 104 can adapt a general purpose ASR. SLU training module 104 can be configured to input domain specific audio data and verbatim transcription data into the general purpose ASR and tune the output to be more in line with the domain. For example, call center audio data and verbatim transcript from a travel company may be fed into the acoustic embedding network and prediction network of the ASR.

In an embodiment, SLU training module 104 can train an adapted or general purpose ASR to a SLU model. In some embodiments, SLU training module 104 can modify the weights of the prediction network. Additionally, SLU training module 104 can add additional output nodes to the joint network. The additional output nodes can correspond to any entity and/or intent labels from the domain specific audio data.

Spoken language database 106 is a database that can be configured to store ASR architecture configurations. Spoken language database 106 may also store data used for training purposes, for example, general purpose audio data, domain specific audio data, verbatim transcripts for general purpose audio data, verbatim transcripts for domain specific audio data, entity labels with corresponding values associated with the entity labels, and intent labels with corresponding values associated with intent labels.

In some embodiments, audio data (e.g., general purpose and domain specific audio data) stored spoken language database 106 can be utterances from one or more human speakers. For example, recorded conversations of call center data (e.g., from a travel company, bank, healthcare, insurance, etc. . . . ) may be stored on spoken language database. Additionally, domain specific audio data may include recordings of financial news broadcasts, sports news broadcasts, motion picture recordings, recorded live-stream events, etc.

In some embodiments, domain specific audio data containing humans speaking utterances may not be available. In such cases, if a verbatim transcript of the occurrence is available with entity labels and/or intent labels, a recording from text-to-speech of the verbatim transcription can be stored on spoken language database 106. For example, Watson® by IBM® may be used to create a recording of a verbatim transcript, which can be stored on spoken language database 106.

In some embodiments, verbatim transcripts for audio data may be stored on spoken language database 106. The verbatim transcripts can be machine generated or human transcribed. The verbatim transcripts may be for general purpose audio data or domain specific audio data. For example, the transcript of a domain specific audio data from a travel company may contain the text from a call center: “I would like a flight to Dallas from Reno that makes a stop in Las Vegas”.

In an embodiment, entity labels may be stored on spoken language database 106. Entity labels are associated with important keywords within the domain. The entity labels may be associated with domain specific audio data, a verbatim transcript for a domain specific training set, or both the domain specific audio data and verbatim transcript for a domain specific set. For example, the entity labels for the example in the immediately preceding paragraph would be “Dallas_{B-toloc.cityname}; Reno_{B-fromloc.cityname}; Las_{B-stoploc.cityname}; Vegas_{I-stoploc.cityname}”.

Additionally, in an embodiment, values associated with labels may be stored on spoken language database 106. For example, a label may be “toloc.cityname” and the associated value can be Dallas.

In another embodiment, intent labels may be stored on spoken language database 106. Intent labels are for entire sentences or clauses and attribute the desire of the speaker for the utterance. For example, in the intent label for the following sentence, “I would like a flight to Dallas from Reno that makes a stop in Las Vegas.” would be “INT-FLIGHT”.

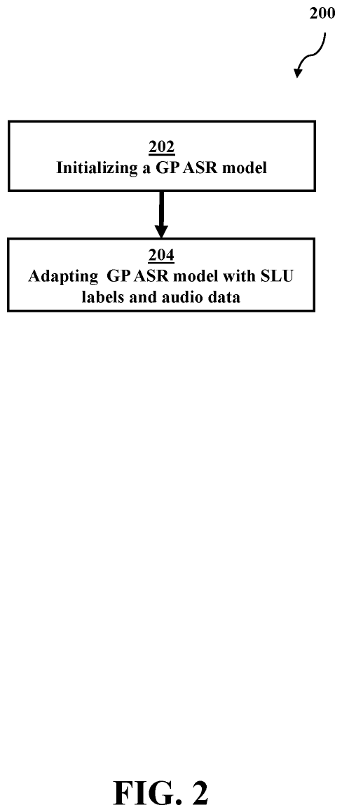

FIG. 2 is a flowchart depicting method 200 for event driven smart device control, in accordance with an embodiment of the present invention.

At step 202, SLU training module 104 initializes a general purpose ASR model. In some embodiments, general purpose training data may be accessed via spoken language database. The general purpose training data can be applied to an untrained ASR model. In some embodiments, the ASR model may have a predetermined architecture, or it may be modified by SLU training module 104 to have a number of output nodes corresponding to phonemes and words within the general purpose training data. Further, if the general purpose training data also contains labels, the output layer may also be modified to contain a number of output nodes for the labels.

At step 204, SLU training module 104 adapts the general purpose ASR model into a Domain specific SLU model. In an embodiment, SLU training module 104 can add additional nodes to a prediction network corresponding to the domain specific labels from spoken language database 106. Further, SLU training module 104 can modify the embedding layer of a prediction network. In yet another embodiment, SLU training module 104 can save an adaptation configuration of the general purpose ASR model as a patch, for future use with a general purpose ASR model on a cloud based speech-to-text service.

FIG. 3 depicts an exemplary block diagram of an end-to-end RNN-T SLU model architecture 300, in accordance with an embodiment of the invention.

Input speech 302 can be a spoken utterance. In an embodiment, the speech can be from a corpus (e.g., call center data, ATIS, Switchboard corpus). The speech can also be from a live person or from a text-to-speech synthesizer.

Transcription network 304 is a recurrent neural network. Transcription network 304 can be an acoustic model. The CTC acoustic model can be a recurrent neural network (e.g., LSTM or BERT). It can be unidirectional or bidirectional. In an embodiment, transcription network can identify phonemes and graphemes of input utterances. Further, transcription network 304 can be adapted to a domain. In some embodiments, transcription network can generate stacked encoding vectors, corresponding to an utterance sequence. The stacked encoding vectors can indicate the probability a sample of the utterance is a phoneme.

Prediction network 306 is a recurrent neural network. Prediction network 306 can receive the output of the joint network and generate a prediction embedding for the utterance of which grapheme or spoken language understanding label corresponds to the spoken utterance.

Joint network 308 is a recurrent neural network. Joint network 308 can receive the stacked encoding vectors of the transcription network 304 and the prediction embeddings of prediction network 306. Joint network 308 can project and combine the received outputs of transcription network 304 and prediction network 306 to determine which entity/intent label and phoneme/grapheme the spoken utterance corresponds.

Output 310 is the computer understandable product of the SLU model. Output 301 can be received by a chatbot or a question answer program (not pictured). In some embodiments, output 310 may be used to direct individuals to the correct geographic location or to answer questions relating to financial, medical, or entertainment domains.

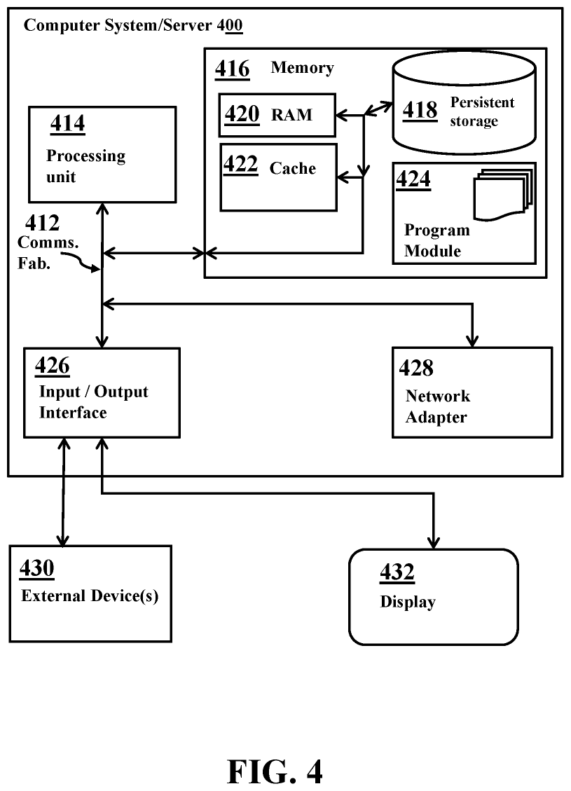

FIG. 4 depicts computer system 400, an example computer system representative of servers 102, or any other computing device within an embodiment of the invention. Computer system 400 includes communications fabric 412, which provides communications between computer processor(s) 414, memory 416, persistent storage 418, network adaptor 428, and input/output (I/O) interface(s) 426. Communications fabric 412 can be implemented with any architecture designed for passing data and/or control information between processors (such as microprocessors, communications and network processors, etc.), system memory, peripheral devices, and any other hardware components within a system. For example, communications fabric 412 can be implemented with one or more buses.

Computer system 400 includes processors 414, cache 422, memory 416, network adaptor 428, input/output (I/O) interface(s) 426 and communications fabric 412. Communications fabric 412 provides communications between cache 422, memory 416, persistent storage 418, network adaptor 428, and input/output (I/O) interface(s) 426. Communications fabric 412 can be implemented with any architecture designed for passing data and/or control information between processors (such as microprocessors, communications and network processors, etc.), system memory, peripheral devices, and any other hardware components within a system. For example, communications fabric 412 can be implemented with one or more buses or a crossbar switch.

Memory 416 and persistent storage 418 are computer readable storage media. In this embodiment, memory 416 includes persistent storage 418, random access memory (RAM) 420, cache 422 and program module 424. In general, memory 416 can include any suitable volatile or non-volatile computer readable storage media. Cache 422 is a fast memory that enhances the performance of processors 414 by holding recently accessed data, and data near recently accessed data, from memory 416. As will be further depicted and described below, memory 416 may include at least one of program module 424 that is configured to carry out the functions of embodiments of the invention.

The program/utility, having at least one program module 424, may be stored in memory 416 by way of example, and not limiting, as well as an operating system, one or more application programs, other program modules, and program data. Each of the operating systems, one or more application programs, other program modules, and program data or some combination thereof, may include an implementation of a networking environment. Program module 424 generally carries out the functions and/or methodologies of embodiments of the invention, as described herein.

Program instructions and data used to practice embodiments of the present invention may be stored in persistent storage 418 and in memory 416 for execution by one or more of the respective processors 414 via cache 422. In an embodiment, persistent storage 418 includes a magnetic hard disk drive. Alternatively, or in addition to a magnetic hard disk drive, persistent storage 418 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 418 may also be removable. For example, a removable hard drive may be used for persistent storage 418. Other examples include optical and magnetic disks, thumb drives, and smart cards that are inserted into a drive for transfer onto another computer readable storage medium that is also part of persistent storage 418.

Network adaptor 428, in these examples, provides for communications with other data processing systems or devices. In these examples, network adaptor 428 includes one or more network interface cards. Network adaptor 428 may provide communications through the use of either or both physical and wireless communications links. Program instructions and data used to practice embodiments of the present invention may be downloaded to persistent storage 418 through network adaptor 428.

I/O interface(s) 426 allows for input and output of data with other devices that may be connected to each computer system. For example, I/O interface 426 may provide a connection to external devices 430 such as a keyboard, keypad, a touch screen, and/or some other suitable input device. External devices 430 can also include portable computer readable storage media such as, for example, thumb drives, portable optical or magnetic disks, and memory cards. Software and data used to practice embodiments of the present invention can be stored on such portable computer readable storage media and can be loaded onto persistent storage 418 via I/O interface(s) 426. I/O interface(s) 426 also connect to display 432.

Display 432 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

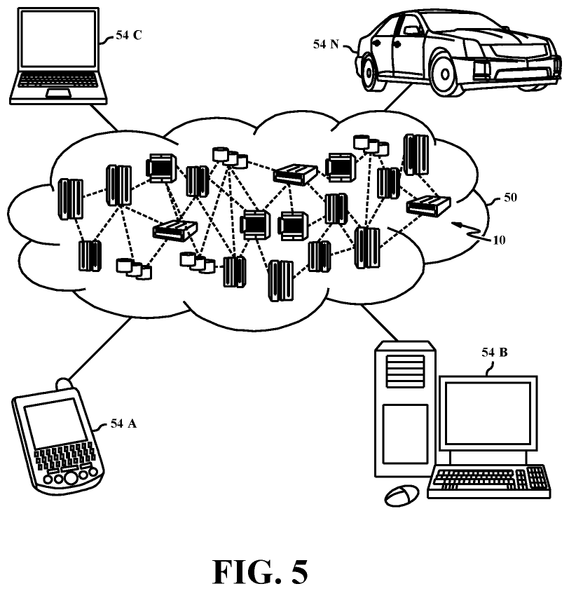

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

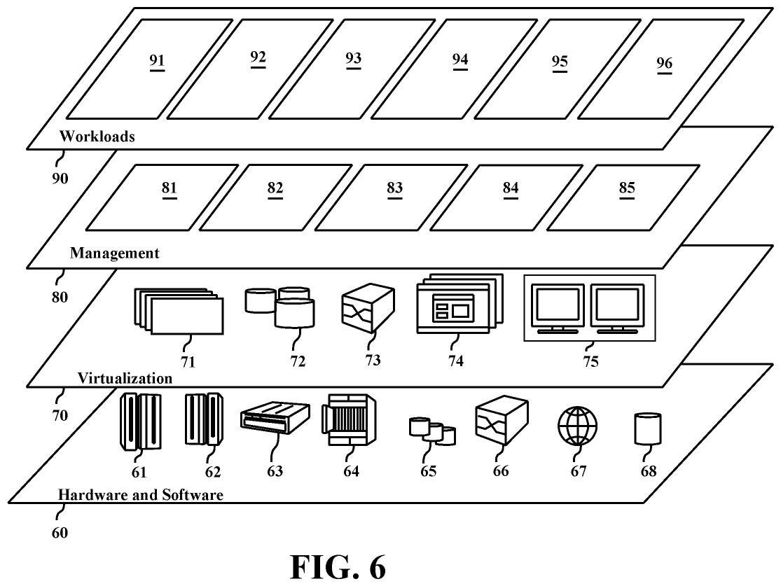

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and spoken language understanding training 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The following are example embodiments of the present invention. In an embodiment, a pre-trained general purpose ASR model is provided. In the following example, a full training data set is provided. The ASR model are pre-trained using task independent ASR data (e.g., Switchboard Corpus) The in this example, the models are trained on different amounts of data: 64 hours, 160 hours, and 300 hours. The pretraining process comprises initializing the transcription network of CTC acoustic models. After pre-training, the RNN-T of the ASR model is adapted (called ASR adapting) using the audio data and the verbatim transcripts. Following the ASR adapting, SLU adapting occurs. SLU adapting is transfer learning of SLU training where the model is adapted on the same audio data with words and semantic labels. In SLU adaptation additional output nodes are added to the joint network. For example, 151 extra output nodes are added to the ATIS entity/intent ASR model corresponding to the entity/intent labels within the ATIS corpus.

In another example, only audio data and SLU labels are available. In this example, the speech utterances for SLU training are annotated only with entity labels/value pairs and or intent labels. The entity label value may not be in spoken order. In some cases, only a single intent label that represents the meaning of the entire utterance may be available. In this example, a pre-trained ASR model is adapted to the using the audio data and corresponding SLU labels (e.g., entity and/or intent).

In another example, transcripts with SLU annotations may be available. In this scenario, a text-to-speech synthesizer may be utilized to produce spoken utterances for training. For example, audio data may be considered personally identifying, therefore, it may be against local or national laws to use the human voices from audio data. Additionally, audio data may not exist in some scenarios, such as when transcripts are from text based chatbots or when a customer interacts with a customer service rep via instant messaging chat or short message service. The pre-trained ASR model may be adapted to the domain using the transcripts and the corresponding text-to-speech utterances (i.e. ASR tuning). Further, the tuned ASR model may be adapted to the SLU through transfer learning of the ASR model with the text-to-speech utterances and SLU labels.

It should be noted, the SLU labels may be the only output of an adapted SLU model. For example, a financial entity customer call center bot may ask a customer “in a few words, how can I help you.” The customer may say I would like to check my savings account balance.” In this example, the adapted SLU model can identity only the domain specific entity label and value and the intent label. The words “check:_{B-action}”, “savings:_{B-acctype}”, and “balance_{B-actionresult}” are values with corresponding labels attached. While the intent label for the sentence would be “_{INT-balancerequest}”. In this example, the call center bot will access a worksheet for balance request based on the intent label and input the entity values into corresponding label queries. The inputs into the worksheet would bring up an additional question related to the original question and cause the call center bot to ask additional questions. For example: “okay, what is your name, account number, and phone number.” This would cause the SLU model to further process the customer's utterances since the SLU model can still identify general purpose speech-to-text utterances and identify the required information to complete the request.

What is claimed is:

1. A computer-implemented method for training an end-to-end spoken language understanding model, the method comprising:
initializing, by a processor, a general purpose automatic speech recognition model; and
adapting, by the processor, the general purpose automatic speech recognition model in a specific domain, wherein the training data is a plurality of audio recordings and a plurality of spoken language understanding labels associated with the audio recordings.

2. The computer-implemented method of claim 1, further comprising:
tuning, by the processor, the general purpose automatic speech recognition model to the specific domain, wherein the training data is comprised of the plurality of recordings and a plurality of verbatim transcripts associated with the plurality of domain specific audio recordings.

3. The computer-implemented method of claim 1, wherein adapting comprises:
generating an adapting configuration of the general purpose ASR model by:
adding, by the processor, one or more additional output nodes to the general purpose automatic speech recognition model;
updating, by the processor, one or more parameters within the general purpose automatic speech recognition model; and
storing, by the processor, the adapting configuration as a lightweight patch.

4. The computer-implemented method of claim 1, wherein the plurality of audio recordings is utterances from one or more humans.

5. The computer-implemented method of claim 1, wherein the spoken language understanding labels are comprised of at least one of the following: a plurality of entity labels and a plurality of intent labels.

6. The computer-implemented method of claim 4, wherein the plurality of entity labels each have a corresponding value associated with it.

7. The computer-implemented method of claim 1, wherein the plurality of audio recordings is artificially synthesized text-to-speech, based on the verbatim transcripts.

8. A computer system for training an end-to-end spoken language understanding model comprising:
a memory; and
a processor in communication with the memory, the processor being configured to perform operations comprising:
initialize a general purpose automatic speech recognition model; and
adapt the general purpose automatic speech recognition model to a specific domain, wherein the training data is the plurality of audio recordings and a plurality of spoken language understanding labels associated with the audio recordings.

9. The computer system of claim 8, further comprising:
tune the general purpose automatic speech recognition model to the specific domain, wherein the training data is comprised of the plurality of domain specific audio recordings and a plurality of verbatim transcripts associated the plurality of domain specific audio recordings.

10. The computer system of claim 8, wherein adapt comprises:
generate an adapting configuration of the general purpose ASR model by:
add one or more additional output nodes to the general purpose automatic speech recognition model;
update one or more parameters within the general purpose automatic speech recognition model; and
store the adapting configuration as a lightweight patch.

11. The computer system of claim 9, wherein the plurality of audio recordings is utterances from one or more humans.

12. The computer system of claim 8, wherein the spoken language understanding labels are comprised of at least one of the following: a plurality of entity labels and a plurality of intent labels.

13. The computer system of claim 11, wherein the plurality of entity labels each have a corresponding value associated with it.

14. The computer system of claim 8, wherein the plurality of audio recordings is artificially synthesized text-to-speech, based on the verbatim transcripts.

15. A computer program product for training an end-to-end spoken language understanding model having program instructions embodied therewith, the program instructions executable by a processor to cause the processors to perform a function, the function comprising:
initialize a general purpose automatic speech recognition model, wherein the general purpose training data is comprised of a plurality of audio recordings and associated verbatim transcripts; and
train the general purpose automatic speech recognition model in a specific domain, wherein the training data is the plurality of audio recordings and a plurality of spoken language understanding labels associated with the audio recordings.

16. The computer program product of claim 15, further comprising:
tune the general purpose automatic speech recognition model to the specific domain, wherein the training data is comprised of the plurality of domain specific audio recordings and a plurality of verbatim transcripts associated the plurality of domain specific audio recordings.

17. The computer program product of claim 15, wherein adapt comprises:
generate an adapting configuration of the general purpose ASR model by:
add one or more additional output nodes to the general purpose automatic speech recognition model;
update one or more parameters within the general purpose automatic speech recognition model; and
store the adapting configuration as a lightweight patch.

18. The computer program product of claim 15, wherein the plurality of audio recordings is utterances from one or more humans.

19. The computer program product of claim 15, wherein the spoken language understanding labels are comprised of at least one of the following: a plurality of entity labels and a plurality of intent labels.

20. The computer program product of claim 15, wherein the plurality of audio recordings is artificially synthesized text-to-speech, based on the verbatim transcripts.
